(19) United States
(12) Patent Application Publication
(10) Pub. No.: US 2023/0004579 A1
(43) Pub. Date: Jan. 5, 2023

(54) METHOD OF CONTROLLING AND HANDLING A SET OF CONDITIONS IN AN EVENT HANDLING SYSTEM WITH MANY COMPLEX INTERNAL CONDITIONS

(71) Applicant: VIETTEL GROUP, Ha Noi City (VN)

(72) Inventors: Van Chung Trinh, Ha Noi City (VN); Duc Hai Nguyen, Tien Du District (VN); Tuan Anh Pham, Ha Noi City (VN); Van Manh Phan, Ha Noi City (VN); Dinh Hung Nguyen, Ha Nam Province (VN)

(73) Assignee: VIETTEL GROUP, Ha Noi City (VN)

(21) Appl. No.: 17/568,271

(22) Filed: Jan. 4, 2022

(30) Foreign Application Priority Data
Jul. 2, 2021 (VN) 1-2021-04075

(51) Int. Cl. G06F 16/28; G06F 9/54

(52) U.S. Cl. CPC G06F 16/285; G06F 9/542

(57) ABSTRACT

The present invention provides a method to control and process a set of conditions in an event handling system with many complex intrinsic conditions, including: step 1: receive the list of conditions; step 2: use the list data structure; step 3: break down the conditions; step 4: Classification; step 5: link the clauses.

### TECHNICAL AREA

The present invention provides a method for controlling and handling a set of conditions in an event handling system with many complex intrinsic conditions. Specifically, the method of controlling and handling a set of conditions in an event handling system with many complex conditions helps to simplify complex conditions for the fastest and most accurate execution time, avoiding taking time to process and cumbersome and complicated conditional logic.

### THE TECHNICAL STATUS OF THE INVENTION

With a system consisting of many complex rules, it is common to follow the following stages:

Stage 1: the mining operator creates a new set of rules;

B1: select clauses including left hand side, comparison operator, right side;

B2: select the operator to join the clauses;

B3: select the result if the condition is true.

Stage 2: implementation;

B1: system to receive and preprocess the information to be included in the condition;

B2: put information in each clause in each condition;

B3: execute the clauses and give the results of the conditional.

In which, step B1 in stage 1 is the step where the operator is prone to making mistakes due to: it is possible that previous conditions have been duplicated or conflicted, needing to be reviewed very carefully

In which, step B3 in stage 2 is the most time-consuming step because there exist complex conditional sentences including AND operator and OR operator. The system needs to execute all the clauses in the conditional before giving the result.

Currently in the world there is no technical solution to solve the limitations listed above.

### THE TECHNICAL NATURE OF THE INVENTION

The object of the present invention is to propose a method to control and handle a set of conditions in a complex event-handling system with many intrinsic conditions that address the limitations set forth above.

The principle of implementation of the method mentioned in the present invention is as follows: receiving a set of filter conditions, separating conditions, classification, reconstructing conditions, filtering input data according to set of conditions reconstructed.

Specifically, the method mentioned in the present invention consists of steps:

Step 1: receive the list of management execution conditions and save the filter conditions from the system operator; the input of this step is a list of management execution conditions from the system operator's request, the output of this step is the digitized filter conditions and the initial version is saved to the database.

Step 2: store and handle the problem of conditional sentence separation; At this step, with the input filter condition digitized in step 1, the method uses a list data structure to store and handle the problem of conditional sentence separation. The output of step 2 is a list data structure consisting of a set of simple conditional statements that are separated.

Step 3: break down the conditions into clauses; Each clause consists of a left hand side, a right hand side and a comparison operator, separating complex conditions into simpler conditions, the output is a set of conditions converted to simple form, with input as a data structure. Whether the list consists of a simple set of conditional sentences extracted in step 2. The output of step 3 is the delimited clauses from the conditional.

Step 4: Classification; At this step, proceed to group the left sides of the conditional expression into classes according to a common feature, from which we find the output is a list of classes of the left-hand side with the same value, each group is called is a class, whose input is the set of left-hand sides of the proposition retrieved in step 3.

Step 5: link clauses each class is considered a node; At this step, proceed to link the clauses each class is considered as a node from the classes defined to produce the output of the corresponding nodes, connecting the nodes together to form a new structure, a conditional sentence. The event will consist of nodes linked together, with as input the KEY-VALUE data structure generated in step 4.

In another embodiment, the present invention relates to a method of controlling and processing a set of conditions in an event handling system with complex intrinsic conditions in which:

In step 1, the preprocessor module receives the initial condition list, uses a database interaction method supported by the programming language to store the initial version history of the condition list get the initial condition list, use the database interaction method supported by the programming language to save the initial version history of the condition list.

In another embodiment, the present invention relates to a method of controlling and processing a set of conditions in an event handling system with complex intrinsic conditions in which:

In step 1, the list data is digitized in preparation for the next step.

In another embodiment, the present invention relates to a method of controlling and processing a set of conditions in an event handling system with complex intrinsic conditions in which:

In step 2, from the set of filter conditions, the condition decomposition subsystem is obtained through each filter condition.

In another embodiment, the present invention relates to a method of controlling and processing a set of conditions in an event handling system with complex intrinsic conditions in which:

In step 2, a conditional has the following form: if cause then effect.

In another embodiment, the present invention relates to a method of controlling and processing a set of conditions in an event handling system with complex intrinsic conditions in which:

In step 2, the cause part of the condition includes clauses, by convention the clauses outside the round brackets the linking operator is AND, all conditions in the parentheses then the binding operator is OR.

In another embodiment, the present invention relates to a method of controlling and processing a set of conditions in an event handling system with complex intrinsic conditions in which:

In step 2, browse the filter clause from left to right, splitting it into combinations, each of which is separated by an operator and, thus, there are combinations that are propositions and there are combinations that are clusters of clauses in brackets circle.

In another embodiment, the present invention relates to a method of controlling and processing a set of conditions in an event handling system with complex intrinsic conditions in which:

In step 2, make the split clauses into a separate list data structure.

In another embodiment, the present invention relates to a method of controlling and processing a set of conditions in an event handling system with complex intrinsic conditions in which:

In step 2, the combinations are the set of conditions in parentheses, continue to separate the sub-conditions in the combinations in brackets, each condition is separated by OR, put these conditions in List structure so that each parenthesis combination is a list.

In another embodiment, the present invention relates to a method of controlling and processing a set of conditions in an event handling system with complex intrinsic conditions where:

In step 2, new conditional expressions are generated in the following way: concatenate the clauses in the operator's own data structure and, then take this set, concatenate with k1 conditions of the list in turn a combination or any, gets new clauses (k1), these clauses are concatenated with the list in a combination or any other next (k2) gets (k1×k2) clauses, continue until all combinations OR.

In another embodiment, the present invention relates to a method of controlling and processing a set of conditions in an event handling system with complex intrinsic conditions in which:

In step 2, let's call the total number of split conditionals s, the value of s is calculated as the product of the number of split conditions in combinations OR.

In another embodiment, the present invention relates to a method of controlling and processing a set of conditions in an event handling system with complex intrinsic conditions in which:

In step 2, put all the newly extracted conditions into the list data structure.

In another embodiment, the present invention relates to a method of controlling and processing a set of conditions in an event handling system with complex intrinsic conditions in which:

In step 3, the condition decomposition module after splitting the condition, produces a new set of list of propositions.

In another embodiment, the present invention relates to a method of controlling and processing a set of conditions in an event handling system with complex intrinsic conditions in which:

In step 3, browse each clause, perform a second split, and split according to the logical operator AND in the conditional.

In another embodiment, the present invention relates to a method of controlling and processing a set of conditions in an event handling system with complex intrinsic conditions in which:

In step 3, browse each clause, perform split according to the logical operator AND in the conditional.

In another embodiment, the present invention relates to a method of controlling and processing a set of conditions in an event handling system with complex intrinsic conditions in which:

In step 4, the Classification generation submodule grouping the left-hand side expressions that are the same is put into the same class.

In another embodiment, the present invention relates to a method of controlling and processing a set of conditions in an event handling system with complex intrinsic conditions in which:

In step 4, Classification generation submodule supports grouping conditions with the same class, so that if a set of conditions has the same set of classes, it only needs to be checked once for all conditions in the set there.

In another embodiment, the present invention relates to a method of controlling and processing a set of conditions in an event handling system with complex intrinsic conditions in which:

In step 4, within the same class there are different values describing the corresponding right-hand side expression of the class.

In another embodiment, the present invention relates to a method of controlling and processing a set of conditions in an event handling system with complex intrinsic conditions in which:

In step 4, use key-value data structures and set data structures to represent.

In another embodiment, the present invention relates to a method of controlling and processing a set of conditions in an event handling system with complex intrinsic conditions in which:

In step 4, the KEY-VALUE data structure describes the information of the divided classes, the key is the names of the classes, and the value is the set of right-hand expressions corresponding to the class.

In another embodiment, the present invention relates to a method of controlling and processing a set of conditions in an event handling system with complex intrinsic conditions in which:

In step 4, the set data structure includes objects that describe the information of each right-hand expression.

In another embodiment, the present invention relates to a method of controlling and processing a set of conditions in an event handling system with complex intrinsic conditions in which:

In step 5, use the serial and branch model to describe.

In another embodiment, the present invention relates to a method of controlling and processing a set of conditions in an event handling system with complex intrinsic conditions in which:

In step 5, the refactoring module implements each built-in class into an object, in the object describing the identifying information of the condition containing that class, the value of the expression on the left side corresponding to each class.

In another embodiment, the present invention relates to a method of controlling and processing a set of conditions in an event handling system with complex intrinsic conditions in which:

In step 5, each layer is considered a node in the model.

In another embodiment, the present invention relates to a method of controlling and processing a set of conditions in an event handling system with complex intrinsic conditions in which:

In step 5, the clauses are described in the node, a large conditional will include the clause nodes connected together, finally to the right of the conditional clause, which is also the result to be taken.

### BRIEF DESCRIPTION OF THE DRAWINGS

In order for the invention to be described more clearly, the figures below describe parts of the invention:

FIG. 1 is model of the processing blocks according to the invention;

FIG. 2 is model of processing flow according to the invention;

FIG. 3 is model for storing new conditionals in a data structure according to the invention;

FIG. 4 is model of simple conditions according to the invention;

FIG. 5 is model of key-value classification description according to the invention;

FIG. 6 is model of sequential or branch clauses according to the invention.

### DETAILED DESCRIPTION

The invention detailed below is based on the accompanying drawings, which are intended to illustrate variations of the present invention without limiting the scope of the patent.

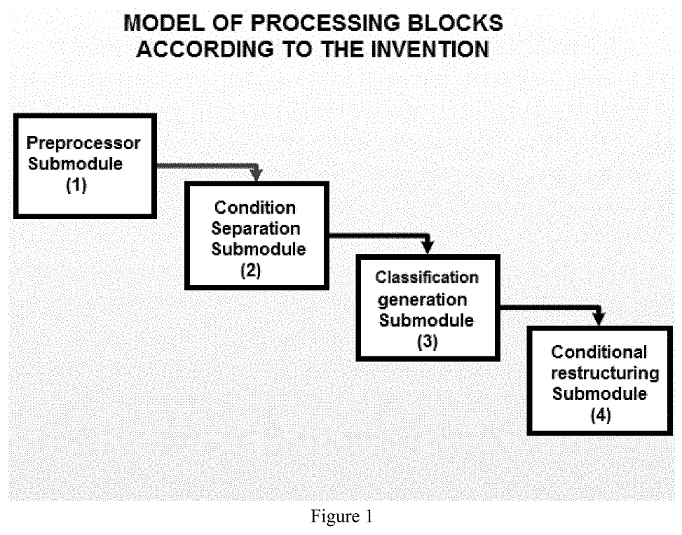

Referring to FIG. 1, model of the processing blocks according to the invention:

Preprocessor submodule (1) is responsible for managing and saving filter conditions from system operators, the output of which is digitized filter conditions and saving the initial version in the database;

Condition Separation submodule (2) is responsible for separating complex conditions into simpler conditions, the output is a set of conditions converted to simple form;

Classification generation submodule (3) is responsible for grouping the left sides of the conditional expression into classes according to a common characteristic, from which a list of classes of the left sides have the same value, each group is called a class;

Conditional restructuring submodule (4) is responsible for connecting nodes together to form a new structure, a conditional sentence will include linked nodes;

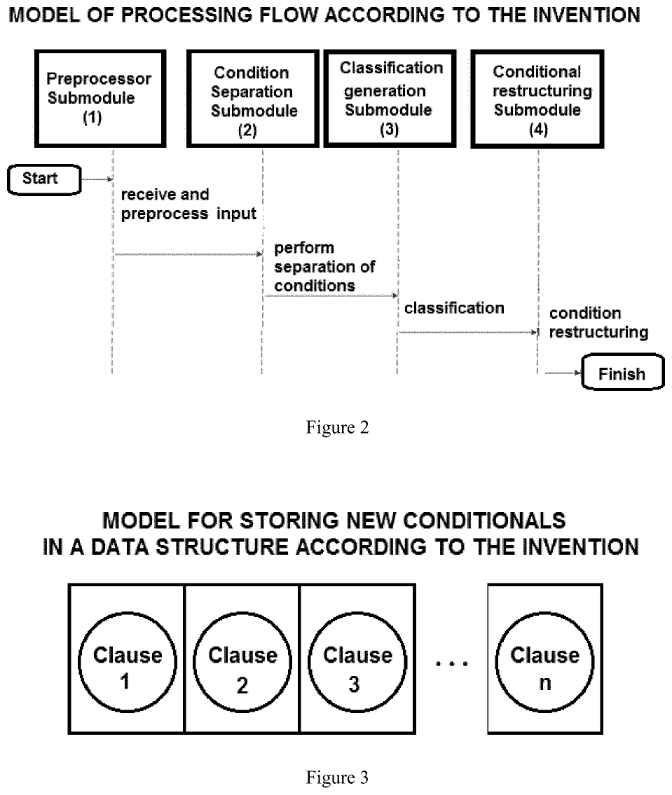

Referring to FIG. 2, model of processing flow according to the invention consists of steps:

Step 1: receive the list of management execution conditions and save the filter conditions from the system operator; the input of this step is a list of management execution conditions from the system operator's request, the output of this step is the digitized filter conditions and the initial version is saved to the database.

Step 2: store and handle the problem of conditional sentence separation; At this step, with the input filter condition digitized in step 1, the method uses a list data structure to store and handle the problem of conditional sentence separation. The output of step 2 is a list data structure consisting of a set of simple conditional statements that are separated.

Step 3: break down the conditions into clauses; Each clause consists of a left hand side, a right hand side and a comparison operator, separating complex conditions into simpler conditions, the output is a set of conditions converted to simple form, with input as a data structure whether the list consists of a simple set of conditional extracted in step 2. The output of step 3 is the delimited clauses from the conditional.

Step 4: grouping; At this step, proceed to group the left sides of the conditional expression into classes according to a common feature, from which we find the output is a list of classes of the left-hand side with the same value, each group is called is a class, whose input is the set of left-hand sides of the proposition retrieved in step 3.

Step 5: link clauses each class is considered a node; At this step, proceed to link the clauses each class is considered as a node from the classes defined to produce the output of the corresponding nodes, connecting the nodes together to form a new structure, a conditional sentence. The event will consist of nodes linked together, with as input the KEY-VALUE data structure generated in step 4.

Referring to FIG. 3, the figure depicts the model for storing new conditionals in a data structure according to the invention. The set of conditions is digitized into a string data type. Each condition is treated as an object and stored in an element of the list data structure.

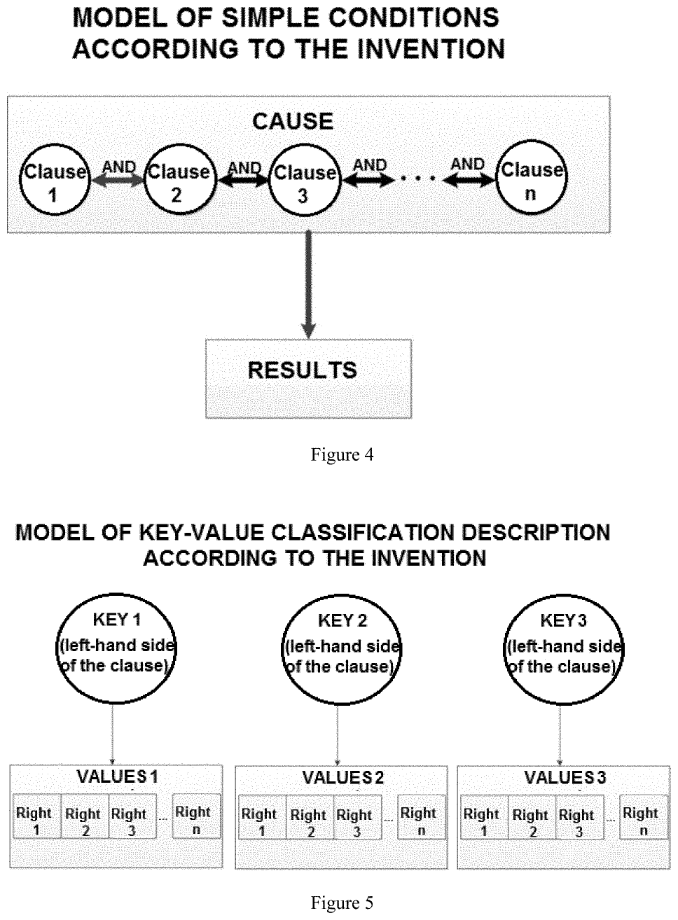

Refer to FIG. 4, the figure depicts the model of simple conditions according to the invention. Accordingly, a simple conditional consists of two blocks: a cause block and a result block. The causal block consists of a set of propositions joined together by the AND operator;

Referring to FIG. 5, the figure depicts the model of key-value classification description according to the invention. Accordingly, each class is described by a key, value data structure, where the key is the left side of the proposition, and the value is the set of right sides of the proposition. Thus, with many classes, we have to use many key and value data structures to describe.

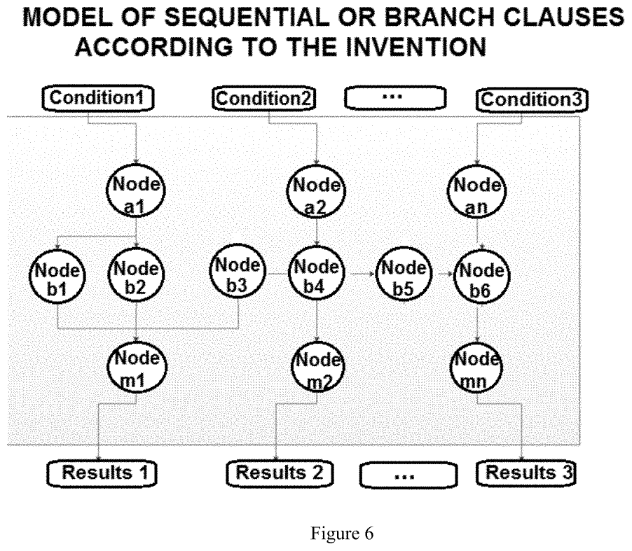

Referring to FIG. 6, the figure depicts the model of sequential or branch clauses according to the invention. Accordingly, each class is considered to be a node, conditional sentences with the left hand side being the key of which node will pass through that node.

According to the first aspect, the present invention provides a method to control and handle a set of conditions in an event handling system with complex intrinsic conditions including:
Step 1: receive the list of conditions;
Step 2: use the list data structure;
Step 3: break down the conditions;
Step 4: Classification;
Step 5: link the clauses.

The first feature of the method of controlling and handling a set of conditions in an event handling system with many complex internal conditions under this option is step 1: receiving a list of conditions for management implementation and save the filter conditions from the system operator, the output of which is the digitized filter conditions and save the original version to the database. The operator of the event management system, acts as a set of filter conditions. The preprocessor module receives the initial condition list, uses a database interaction method supported by the programming language to store the initial version history of the condition list.

List data is digitized in preparation for the next step.

Refer to FIG. 1 and FIG. 2 to see the model of processing blocks and business flow.

The second feature of the method of controlling and processing the set of conditions in the event handling system with many complex intrinsic conditions according to this embodiment is step 2: using a list data structure to store and process the conditional sentence decomposition problem, with the input of the filter condition digitized in step 1. From the set of filter conditions received. The SeparationCondition Sub Module browses each filter condition,

A conditional sentence has the following form: IF cause THEN the effect. A cause part of the condition includes clauses, by convention clauses outside of round brackets the linking operator is AND, all conditions in parentheses then the binding operator is OR.

The structure of the cause part:

(A=a1 OR A=a2 OR . . . ) AND B=b1 AND (C=c1 OR C=c2 . . . ) AND . . . .

Browse the filter clause from left to right, separating into combinations, each separated by AND operator. Thus, there are combinations that are propositional (e.g. B=b1) and there are combinations of clauses enclosed in parentheses (e.g. (A=a1 OR A=a2 OR . . . )). Implement to put the split clauses into a separate list data structure. Combinations are sets of conditions in parentheses, further separating the sub-conditions in the combinations in parentheses, each separated by an OR, put these conditions in a star list structure for each bracket combination is a list.

New conditional expressions are generated in the following way: concatenate clauses in the AND operator's own data structure, then take this set concatenated with k1 conditions of the list in any combination OR, get k1 new clause, these statements are concatenated with k2 lists in a combination OR any other followed by (k1×k2) clauses, continuing until all combinations OR. Let the total number of split conditional sentences be s. The value of s is calculated as the product of the number of conditions separated in groups OR.

s=Total group conditions OR 1×Total group conditions OR 2× . . . Total group conditions OR n.

Put all the newly detached conditions into the list data structure. Refer to FIG. 3: the model for storing new conditionals in a data structure according to the invention.

The third feature of the method of controlling and handling the set of conditions in the event handling system with many complex intrinsic conditions according to this embodiment is step 3: splitting the conditions into clauses, Each clause consists of a left hand side, a right hand side and a comparison operator, separating complex conditions into simpler conditions, the output is a set of conditions converted to simple form, with input as a data structure the list consists of a set of conditional statements in the simple form separated in step 2. Refer to FIG. 4: model of simple conditions according to the invention. The SeparationCondition Sub Module, after separating the conditions, produces a new set of lists of clauses. Browse each clause, perform split second, split by logical operator AND in conditional sentence;

As a result, the propositions are obtained, taking the entire left side of the proposition to get a set of expressions on the left side.

The fourth characteristic of the method of controlling and handling the set of conditions in the event handling system with many complex intrinsic conditions according to this embodiment is step 4: grouping the left sides of the conditional expression into classes according to a common property, from which a list of classes of left-hand sides with the same value is obtained, each group is called a class, with input being the set of left-hand sides of the proposition retrieved in step 3. Refer to FIG. 5: model of key-value classification description according to the invention.

The Classification submodule grouping the left-hand side expressions that are the same is put into the same class.

Classification helps to group conditions that have the same class. Since then, if the set of conditions has the same set of classes, it only needs to be checked once for all conditions in that set.

Within the same class there are different values describing the corresponding right-hand side expression of the class.

Use KEY-VALUE data structure and SET data structure for representation. The KEY-VALUE data structure describes the information the classes are divided into. KEY is the name of the classes, VALUE is the SET of right-hand expressions corresponding to the class. The SET data structure consists of objects that describe the information of each right-hand side expression.

The fifth characteristic of the method of controlling and processing the set of conditions in the event handling system with many complex intrinsic conditions according to this embodiment is step 5: linking the clauses each class is considered to be a node, from the defined classes create corresponding nodes, connect the nodes together to form a new structure, a conditional sentence will consist of linked nodes, with the input as the structure KEY-VALUE data generated in step 4. Refer to FIG. 6: model of sequential or branch clauses according to the invention. Use the serial and branch models to describe.

Restructuring Sub Module implements, each class is built into an object, in the object describes information:

Identifier of the condition containing that class;

The value of the expression on the left hand side corresponding to each class;

Each Class is considered as a node in the model. The clauses described in the node. A large condition will include the clause nodes connected together, finally to the right of the conditional clause, which is also the result to be taken.

According to the next aspect, the present invention provides a method to control and handle a set of conditions in an event handling system with many complex intrinsic conditions in which:

In step 1, the preprocessor module receives the initial condition list, uses a database interaction method supported by the programming language to store the initial version history of the condition list get the initial condition list, use the database interaction method supported by the programming language to save the initial version history of the condition list.

According to the next aspect, the present invention provides a method to control and handle a set of conditions in an event handling system with many complex intrinsic conditions in which:

In step 1, the list data is digitized in preparation for the next step.

According to the next aspect, the present invention provides a method to control and handle a set of conditions in an event handling system with many complex intrinsic conditions in which:

In step 2, from the set of filter conditions, the condition decomposition subsystem is obtained through each filter condition.

According to the next aspect, the present invention provides a method to control and handle a set of conditions in an event handling system with many complex intrinsic conditions in which:

In step 2, a conditional has the following form if cause then effect.

According to the next aspect, the present invention provides a method to control and handle a set of conditions in an event handling system with many complex intrinsic conditions in which:

In step 2, a cause part of the condition includes clauses, by convention the clauses outside the round brackets the linking operator is AND, all conditions in the parentheses then the binding operator is OR.

According to the next aspect, the present invention provides a method to control and handle a set of conditions in an event handling system with many complex intrinsic conditions in which:

In step 2, browse the filter clause from left to right, splitting it into combinations, each of which is separated by an operator and, thus, there are combinations that are propositions and there are combinations that are clusters of clauses in brackets circle.

According to the next aspect, the present invention provides a method to control and handle a set of conditions in an event handling system with many complex intrinsic conditions in which:

In step 2, make the split clauses into a separate list data structure.

According to the next aspect, the present invention provides a method to control and handle a set of conditions in an event handling system with many complex intrinsic conditions in which:

In step 2, the combinations are the set of conditions in parentheses, continue to separate the sub-conditions in the combinations in brackets, each condition is separated by OR, put these conditions in List structure so that each parenthesis combination is a list.

According to the next aspect, the present invention provides a method to control and handle a set of conditions in an event handling system with many complex intrinsic conditions in which:

In step 2, new conditional expressions are generated in the following way: concatenate the clauses in the operator's own data structure and, then take this set, concatenate with k1 conditions of the list in turn a combination or any, gets new clauses (k1), these clauses are concatenated with the list in a combination or any other next (k2) gets (k1×k2) clauses, continue until all combinations OR.

According to the next aspect, the present invention provides a method to control and handle a set of conditions in an event handling system with many complex intrinsic conditions in which:

In step 2, let's call the total number of split conditionals s, the value of s is calculated as the product of the number of split conditions in groups OR.

According to the next aspect, the present invention provides a method to control and handle a set of conditions in an event handling system with many complex intrinsic conditions in which:

In step 2, put all the newly extracted conditions into the list data structure.

According to the next aspect, the present invention provides a method to control and handle a set of conditions in an event handling system with many complex intrinsic conditions in which:

In step 3, the condition decomposition module after splitting the condition, produces a new set of list of propositions.

According to the next aspect, the present invention provides a method to control and handle a set of conditions in an event handling system with many complex intrinsic conditions in which:

In step 3, browse each clause, perform split according to the logical operator AND in the conditional.

According to the next aspect, the present invention provides a method to control and handle a set of conditions in an event handling system with many complex intrinsic conditions in which:

In step 3, the results are obtained propositions, taking the entire left side of the proposition is a set of expressions on the left side.

According to the next aspect, the present invention provides a method to control and handle a set of conditions in an event handling system with many complex intrinsic conditions in which:

In step 4, the class generation module grouping the left-hand side expressions that are the same is put into the same class.

According to the next aspect, the present invention provides a method to control and handle a set of conditions in an event handling system with many complex intrinsic conditions in which:

In step 4, Classification generation submodule supports grouping conditions with the same class, so that if a set of conditions has the same set of classes, it only needs to be checked once for all conditions in the set there.

According to the next aspect, the present invention provides a method to control and handle a set of conditions in an event handling system with many complex intrinsic conditions in which:

In step 4, within the same class there are different values describing the corresponding right-hand side expression of the class.

According to the next aspect, the present invention provides a method to control and handle a set of conditions in an event handling system with many complex intrinsic conditions in which:

In step 4, use key-value data structures and set data structures to represent.

According to the next aspect, the present invention provides a method to control and handle a set of conditions in an event handling system with many complex intrinsic conditions in which:

In step 4, the KEY-VALUE data structure describes the information of the divided classes, the key is the names of the classes, and the value is the set of right-hand expressions corresponding to the class.

According to the next aspect, the present invention provides a method to control and handle a set of conditions in an event handling system with many complex intrinsic conditions in which:

In step 4, the set data structure includes objects that describe the information of each right-hand expression.

According to the next aspect, the present invention provides a method to control and handle a set of conditions in an event handling system with many complex intrinsic conditions in which:

In step 5, use the serial and branch model to describe.

According to the next aspect, the present invention provides a method to control and handle a set of conditions in an event handling system with many complex intrinsic conditions in which:

In step 5, a refactoring module implements each built-in class into an object, in the object describing the identifying information of the condition containing that class, the value of the expression on the left side corresponding to each class.

According to the next aspect, the present invention provides a method to control and handle a set of conditions in an event handling system with many complex intrinsic conditions in which:

In step 5, each layer is considered a node in the model.

According to the next aspect, the present invention provides a method to control and handle a set of conditions in an event handling system with many complex intrinsic conditions in which:

In step 5, the clauses are described in the node, a large conditional will include the clause nodes connected together, finally to the right of the conditional clause, which is also the result to be taken.

### Effectiveness of the Invention

When providing a method to control and handle a set of conditions in a system with many complex conditions, the supplier wants to optimize the system for two main purposes. The first purpose is to simplify the process of declaring the execution condition, avoiding mistakes and duplicate conditions. The second purpose is to reduce the processing time of the system and avoid causing logic errors during execution.

Although the above descriptions contain many specifics, they are not intended to be a limitation on the embodiment of the invention, but are intended only to illustrate some preferred execution options.

1. Method to control and handle a set of conditions in an event handling system with complex intrinsic conditions including:
step 1: receiving a list of conditions for management implementation and save filter conditions from a system operator, the output of which is a digitized filter conditions and save the original version to a database;
step 2: using a list data structure to store and process a conditional sentence decomposition problem, with the input of the filter condition digitized in step 1;
step 3: splitting the conditions into clauses, each clause consists of a left hand side, a right hand side and a comparison operator, separating complex conditions into simpler conditions, the output is a set of conditions converted to simple form, with input as a data structure the list consists of a set of conditional statements in the simple form separated in step 2;
step 4: grouping the left sides of the conditional expression into classes according to a common property, from which a list of classes of left-hand sides with the same value is obtained, each group is called a class, with input being the set of left-hand sides of the proposition retrieved in step 3;
step 5: linking the clauses each class is considered to be a node, from the defined classes create corresponding nodes, connect the nodes together to form a new structure, a conditional sentence will consist of linked nodes, with the input as the structure KEY-VALUE data generated in step 4.

2. The method of controlling and handling a set of conditions in an event handling system with many complex internal conditions according to claim 1, in which:
In step 1, a preprocessor module receives the initial condition list, uses a database interaction method supported by a programming language to store an initial version history of the condition list get the initial condition list, use a database interaction method supported by the programming language to save the initial version history of the condition list.

3. The method of controlling and handling a set of conditions in an event handling system with many complex internal conditions according to claim 1, in which:
In step 1, the list data is digitized in preparation for the next step.

4. The method of controlling and handling a set of conditions in an event handling system with many complex internal conditions according to claim 1, in which:
In step 2, from the set of filter conditions, the condition decomposition subsystem is obtained through each filter condition.

5. The method of controlling and handling a set of conditions in an event handling system with many complex internal conditions according to claim 1 in which:
In step 2, a conditional has the following form: if cause then effect.

6. The method of controlling and handling a set of conditions in an event handling system with many complex internal conditions according to claim 1 in which:
In step 2, a cause part of the condition includes clauses, by convention the clauses outside the round brackets the linking operator is AND, all conditions in the parentheses then the binding operator is OR.

7. The method of controlling and handling a set of conditions in an event handling system with many complex internal conditions according to claim 1, in which:
In step 2, browse the filter clause from left to right, splitting it into combinations, each of which is separated by an operator and, thus, there are combinations that are propositions and there are combinations that are clusters of clauses in brackets circle.

8. The method of controlling and handling a set of conditions in an event handling system with many complex internal conditions according to claim 1, in which:
In step 2, make a split clauses into a separate list data structure.

9. The method of controlling and handling a set of conditions in an event handling system with many complex internal conditions according to claim 1, in which:
In step 2, combinations are the set of conditions in parentheses, continue to separate the sub-conditions in the combinations in brackets, each condition is separated by OR, put these conditions in a List structure so that each parenthesis combination is a list.

10. The method of controlling and handling a set of conditions in an event handling system with many complex internal conditions according to claim 1, in which:
In step 2, new conditional expressions are generated in the following way: concatenate the clauses in the operator's own data structure and, then take this set, concatenate with k1 conditions of the list in turn a combination or any, gets new clauses (k1), these clauses are concatenated with the list in a combination or any other next (k2) gets (k1×k2) clauses, continue until all combinations OR.

11. The method of controlling and handling a set of conditions in an event handling system with many complex internal conditions according to claim 1, in which:
In step 2, given a total number of split conditionals s, the value of s is calculated as the product of the number of split conditions in groups OR.

12. The method of controlling and handling a set of conditions in an event handling system with many complex internal conditions according to claim 1, in which:
In step 2, put all the newly extracted conditions into a list data structure.

13. The method of controlling and handling a set of conditions in an event handling system with many complex internal conditions according to any of the points 1-12, in which:
In step 3, a condition decomposition module after splitting the condition, produces a new set of list of propositions.

14. The method of controlling and handling a set of conditions in an event handling system with many complex internal conditions according to claim 1, in which:
In step 3, browse each clause, perform split according to the logical operator AND in the conditional.

15. The method of controlling and handling a set of conditions in an event handling system with many complex internal conditions according to claim 1, in which:
In step 3, the results are obtained propositions, taking the entire left side of the proposition is a set of expressions on the left side.

16. The method of controlling and handling a set of conditions in an event handling system with many complex internal conditions according to claim 1, in which:
In step 4, a class generation module grouping the left-hand side expressions that are the same is put into the same class.

17. The method of controlling and handling a set of conditions in an event handling system with many complex internal conditions according to claim 1, in which:
In step 4, a Classification generation submodule supports grouping conditions with a same class, so that if a set of conditions has the same set of classes, it only needs to be checked once for all conditions in the set there.

18. The method of controlling and handling a set of conditions in an event handling system with many complex internal conditions according to claim 1, in which:
In step 4, within the same class there are different values describing the corresponding right-hand side expression of the class, Use key-value data structures and set data structures to represent, The KEY-VALUE data structure describes the information of the divided classes, the key is the names of the classes, and the value is the set of right-hand expressions corresponding to the class, The set data structure includes objects that describe the information of each right-hand expression.

19. The method of controlling and handling a set of conditions in an event handling system with many complex internal conditions according to claim 1, in which:
In step 5, use the serial and branch model to describe, A refactoring module implements each built-in class into an object, in the object describing the identifying information of the condition containing that class, the value of the expression on the left side corresponding to each class, each layer is considered a node in the model.

20. The method of controlling and handling a set of conditions in an event handling system with many complex internal conditions according to claim 1, in which:
In step 5, the clauses are described in the node, a large conditional will include the clause nodes connected together, finally to the right of the conditional clause, which is also the result to be taken.
